(19) United States
(12) Patent Application Publication
(10) Pub. No.: US 2025/0105352 A1
(43) Pub. Date: Mar. 27, 2025

(54) SECONDARY BATTERY-USE ELECTROLYTIC SOLUTION AND SECONDARY BATTERY

(71) Applicant: MURATA MANUFACTURING CO., LTD., Kyoto (JP)

(72) Inventors: Tomomi SAKUMA, Kyoto (JP); Kentaro YOSHIMURA, Kyoto (JP); Mashio SHIBUYA, Kyoto (JP)

(21) Appl. No.: 18/910,755

(22) Filed: Oct. 9, 2024

Related U.S. Application Data
(63) Continuation of application No. PCT/JP2023/033951, filed on Sep. 19, 2023.

(30) Foreign Application Priority Data
Sep. 29, 2022 (JP) 2022-156259

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0028

(57) ABSTRACT

A secondary battery includes a positive electrode, a negative electrode, and an electrolytic solution, and the electrolytic solution contains a phenyl isothiocyanate compound represented by Formula (1).

### CROSS REFERENCE TO RELATED APPLICATIONS

The present application is a continuation of PCT patent application no. PCT/JP2023/033951, filed on Sep. 19, 2023, which claims priority to Japanese patent application no. 2022-156259, filed on Sep. 29, 2022, the entire contents of which are incorporated herein by reference.

### BACKGROUND

The present technology relates to a secondary battery-use electrolytic solution and a secondary battery.

Since various electronic devices such as mobile phones have been widely used, a secondary battery, which is smaller in size and lighter in weight and allows for a higher energy density, is under development as a power source. The secondary battery includes a positive electrode, a negative electrode, and an electrolytic solution (secondary battery-use electrolytic solution), and various considerations have been given to the configuration of the secondary battery.

Specifically, an electrolytic solution contains benzothiazole or a derivative thereof. An electrolytic solution contains a quaternary ammonium salt and an additive (unsaturated cyclic compound containing a nitrogen atom).

### SUMMARY

The present technology relates to a secondary battery-use electrolytic solution and a secondary battery.

Various studies on the configuration of the secondary battery have been made, but the battery characteristics of the secondary battery are still insufficient, and therefore there is room for improvement.

A secondary battery-use electrolytic solution and a secondary battery which can obtain excellent battery characteristics are desired.

A secondary battery-use electrolytic solution of an embodiment of the present technology contains a phenyl isothiocyanate compound represented by Formula (1):

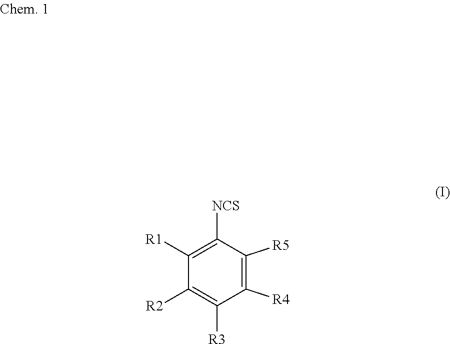

where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.

A secondary battery of an embodiment of the present technology includes a positive electrode, a negative electrode, and an electrolytic solution, and the electrolytic solution has a configuration similar to the configuration of the above-described secondary battery-use electrolytic solution of an embodiment of the present technology.

According to the secondary battery-use electrolytic solution or the secondary battery of an embodiment of the present technology, excellent battery characteristics can be obtained since the secondary battery-use electrolytic solution contains the phenyl isothiocyanate compound.

The effect of the present technology is not necessarily limited to the effect described here, and may be any effect of a series of effects relating to the present technology described later.

### BRIEF DESCRIPTION OF THE FIGURES

FIG. 1 is a sectional view illustrating a configuration of a secondary battery in an embodiment of the present technology.

FIG. 2 is a sectional view illustrating a configuration of a battery element illustrated in FIG. 1.

FIG. 3 is a block diagram illustrating a configuration of an application example of a secondary battery.

### DETAILED DESCRIPTION

Hereinafter, an embodiment of the present technology will be described in further detail including with reference to drawings.

First, a secondary battery-use electrolytic solution (hereinafter, simply referred to as “electrolytic solution”) of an embodiment of the present technology will be described.

The electrolytic solution described herein is used for the secondary battery as an electrochemical device. However, the electrolytic solution may be used for other electrochemical devices which are other than the secondary battery. Specific examples of the other electrochemical devices include a primary battery and a capacitor.

An electrolytic solution is a liquid electrolyte. The electrolytic solution functions as a medium for transferring an electrode reactant between the positive electrode and the negative electrode during charging and discharging of the secondary battery. The electrode reactant is a substance causing a charge-discharge reaction of the secondary battery to proceed, and the details of the electrode reactant will be described later.

The electrolytic solution contains a phenyl isothiocyanate compound. Specifically, the phenyl isothiocyanate compound contains any one kind or two or more kinds of compounds represented by Formula (1).

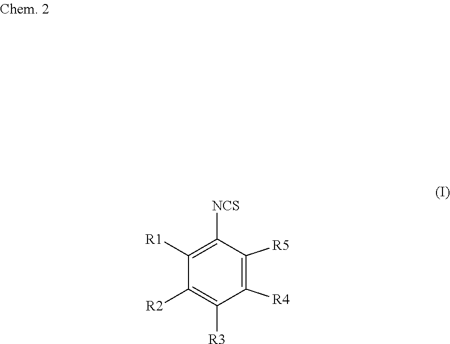

where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.

As is apparent from Formula (1), the phenyl isothiocyanate compound is phenyl isothiocyanate or a derivative thereof, and the phenyl isothiocyanate is a compound in which a phenyl group and an isothiocyanate group (—N═C═S) are bonded to each other.

When the electrolytic solution contains the phenyl isothiocyanate compound, a coating film derived from the phenyl isothiocyanate compound is formed on the surface of the negative electrode during charging and discharging of the secondary battery using the electrolytic solution. Since the coating film has a low electrical resistance, when the overvoltage of the negative electrode increases, the electrode reactant is less likely to precipitate in the negative electrode.

The details of the configuration of the phenyl isothiocyanate compound are as described below.

The number of carbon atoms of the alkyl group is not particularly limited. The alkyl group may be linear or branched. Specific examples of the alkyl group include a methyl group, an ethyl group, and a propyl group.

The number of carbon atoms of the alkoxy group is not particularly limited. The alkoxy group may be linear or branched. Specific examples of the alkoxy group include a methoxy group, an ethoxy group, and a propoxy group.

The number of carbon atoms of the aryl group is not particularly limited. The number of aromatic rings contained in the aryl group may be only one or two or more. Specific examples of the aryl group include a phenyl group and a naphthyl group.

The fluorinated alkyl group is a group in which one or two or more hydrogens in the above-described alkyl group are substituted with fluorine. The fluorinated alkoxy group is a group in which one or two or more hydrogens in the above-described alkoxy group are substituted with fluorine. The fluorinated aryl group is a group in which one or two or more hydrogens in the above-described aryl group are substituted with fluorine.

Specific examples of the phenyl isothiocyanate compound include compounds represented by Formulas (1-1) to (1-19).

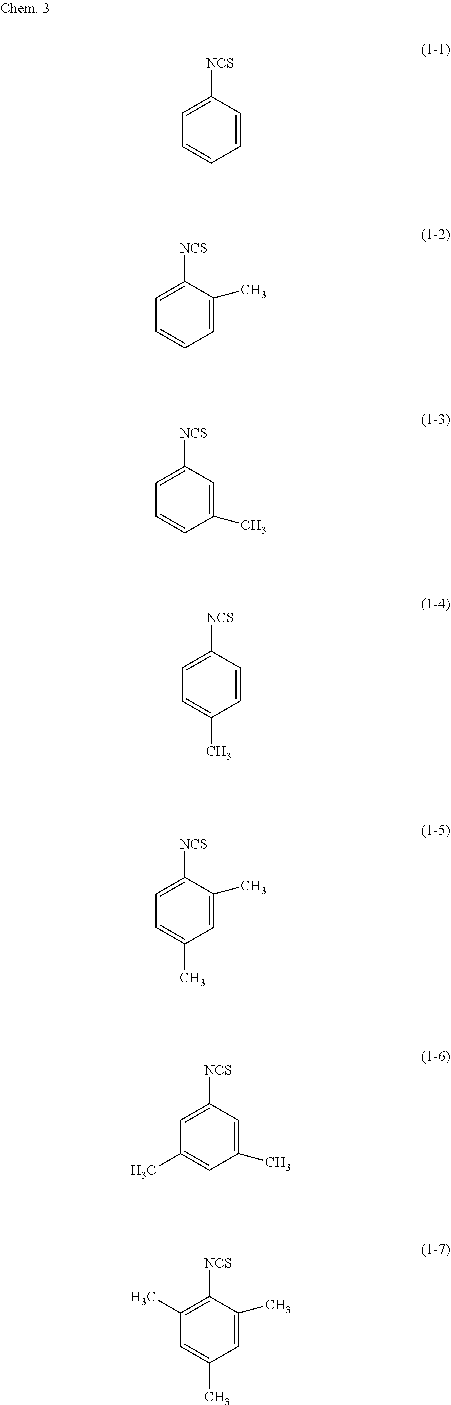

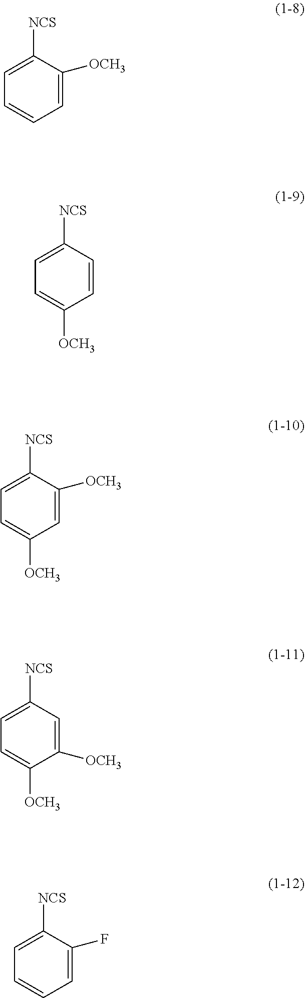

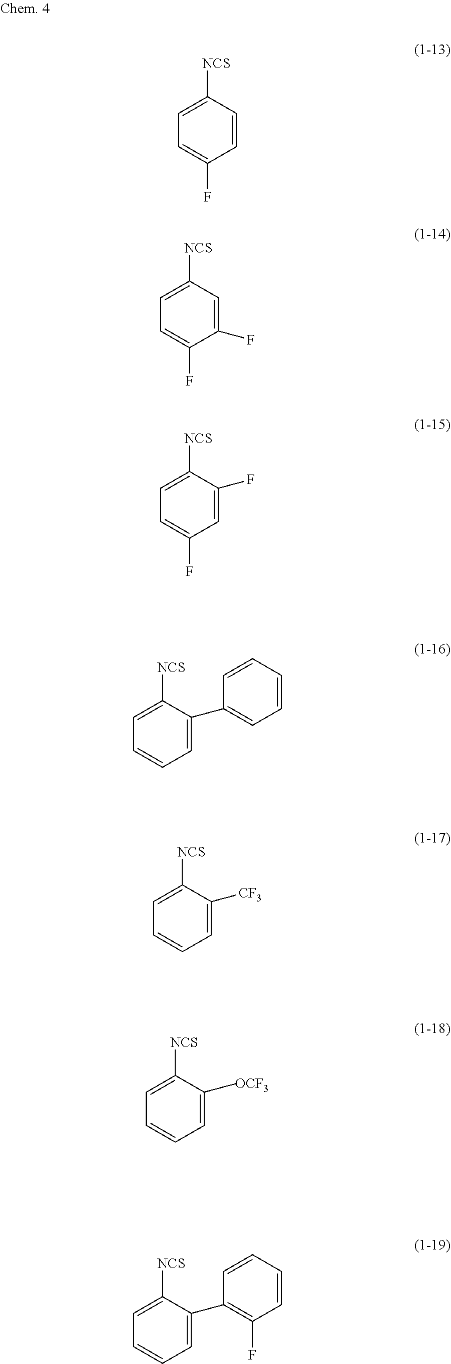

The content of the phenyl isothiocyanate compound in the electrolytic solution is not particularly limited, and is preferably 0.001 wt % to 10 wt %. This is because a favorable coating film derived from the phenyl isothiocyanate compound is easily formed on the surface of the negative electrode.

In the case of measuring the content of the phenyl isothiocyanate compound, the content of the phenyl isothiocyanate compound is calculated by analyzing the electrolytic solution. In the case of using a secondary battery in order to measure the content of the phenyl isothiocyanate compound, the electrolytic solution is recovered by disassembling the secondary battery, and then the electrolytic solution is analyzed.

The method for analyzing the electrolytic solution is not particularly limited, and specifically, is any one kind or two or more kinds of high-frequency induction coupled plasma (ICP) emission spectrometry, nuclear magnetic resonance spectroscopy (NMR), and gas chromatography-mass spectrometry (GC-MS), and the like.

The electrolytic solution may further contain a benzothiazole compound. The benzothiazole compound contains any one kind or two or more kinds of compounds represented by Formula (2).

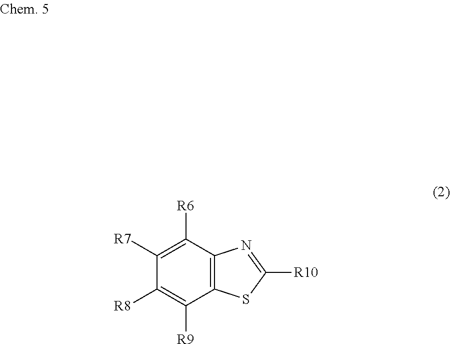

where each of R6, R7, R8, R9, and R10 is any of hydrogen, fluorine, an amino group, an alkyl group, a fluorinated alkyl group, an alkoxy group, a fluorinated alkoxy group, an aryl group, a fluorinated aryl group, a carboxylic acid ester group, and a group in which two or more kinds thereof are bonded to each other.

As is apparent from Formula (2), the benzothiazole compound is benzothiazole or a derivative thereof, and the benzothiazole is a compound in which benzene and thiazole are condensed.

The reason why the electrolytic solution contains the benzothiazole compound is that, in the secondary battery using the electrolytic solution, the electrical resistance at the interface between the positive electrode and the electrolytic solution is reduced, so that the electrical resistance of the positive electrode is reduced.

When the electrical resistance of the positive electrode is reduced, the overvoltage of the negative electrode may increase accordingly. However, as described above, when the overvoltage of the negative electrode increases, since the electrolytic solution contains the phenyl isothiocyanate compound, the electrode reactant is less likely to precipitate in the negative electrode.

The details of the configuration of the benzothiazole compound are as described below.

The details of each of the alkyl group, the alkoxy group, the aryl group, the fluorinated alkyl group, the fluorinated alkoxy group, and the fluorinated aryl group are as described above.

The carboxylic acid ester group is a group represented by chemical formula of —C(═O)O—R, and R is an alkyl group. The details of the alkyl group are as described above.

The “group in which two or more kinds thereof are bonded to each other” is a so-called bonding group. The bonding group is a group in which any two or more kinds of hydrogen, fluorine, an amino group, an alkyl group, a fluorinated alkyl group, an alkoxy group, a fluorinated alkoxy group, an aryl group, a fluorinated aryl group, and a carboxylic acid ester group are bonded to each other.

Specific examples of the bonding group include an alkyl carboxylic acid ester group in which an alkyl group and a carboxylic acid ester group are bonded to each other. In this case, since one hydrogen of the alkyl group is substituted with a carboxylic acid ester group, the bonding group is a group in which an alkylene group and a carboxylic acid ester group are bonded to each other.

Specific examples of the bonding group include an alkylamino group in which an alkyl group and an amino group are bonded to each other. In this case, since one hydrogen of the alkyl group is substituted with an amino group, the bonding group is a group in which an alkylene group and an amino group are bonded to each other. Of course, the bonding group may be other groups not exemplified herein.

Specific examples of the benzothiazole compound include compounds represented by Formulas (2-1) to (2-17).

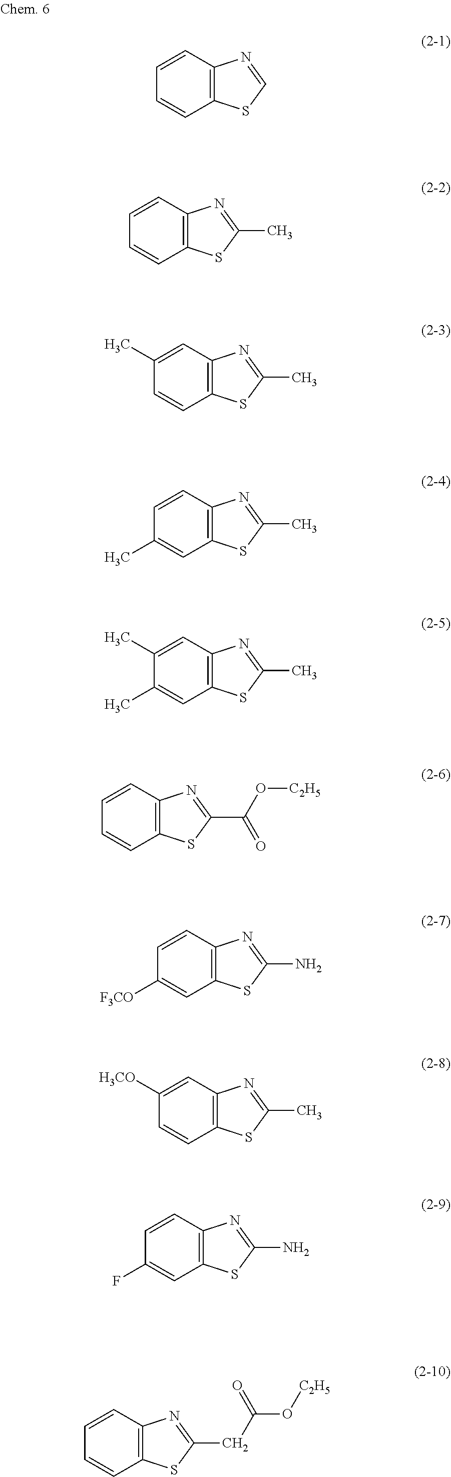

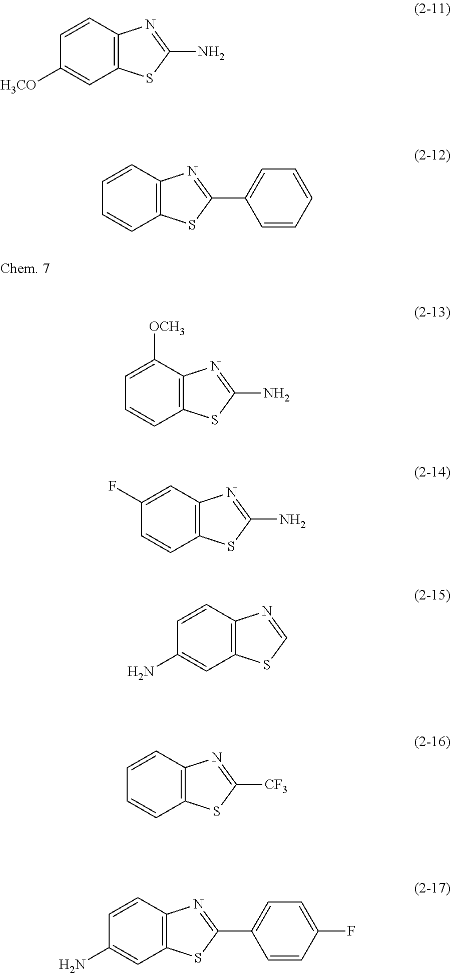

The content of the benzothiazole compound in the electrolytic solution is not particularly limited, and is preferably 0.1 wt % to 10 wt %. This is because the electric resistance at the interface between the positive electrode and the electrolytic solution is further reduced, so that the electrical resistance of the positive electrode is further reduced.

The procedure for measuring the content of the benzothiazole compound is the same as the procedure for measuring the content of the phenyl isothiocyanate compound, except that the content of the benzothiazole compound is calculated instead of the content of the phenyl isothiocyanate compound.

The sum of the content of the phenyl isothiocyanate compound in the electrolytic solution and the content of the benzothiazole compound in the electrolytic solution is not particularly limited as long as the above-described conditions are satisfied with respect to the contents of both compounds. In particular, the sum is preferably 10 wt % or less. This is because the electrical resistance of the positive electrode is sufficiently reduced, and the electrode reactant is less likely to sufficiently precipitate in the negative electrode.

The electrolytic solution may further contain a solvent. The solvent contains any one kind or two or more kinds of non-aqueous solvents (organic solvents), and the electrolytic solution containing the non-aqueous solvent is a so-called non-aqueous electrolytic solution.

The non-aqueous solvent is an ester, an ether, or the like, and more specifically, is a carbonic acid ester-based compound, a carboxylic acid ester-based compound, and a lactone-based compound, or the like.

The carbonic acid ester-based compound is a cyclic carbonic acid ester, a chain carbonic acid ester, and the like. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic acid ester-based compound is a chain carboxylic acid ester or the like. Specific examples of the chain carboxylic acid ester include methyl acetate, ethyl acetate, methyl propionate, ethyl propionate, propyl propionate, ethyl trimethylacetate, methyl butyrate, and ethyl butyrate.

The lactone-based compound is a lactone or the like. Specific examples of the lactone include γ-butyrolactone and γ-valerolactone.

The ethers may be 1,2-dimethoxyethane, tetrahydrofuran, 1,3-dioxolane, 1,4-dioxane, or the like.

The electrolytic solution may further contain an electrolyte salt. The electrolyte salt is a light metal salt such as a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato) borate (LiB(C₂O₄)₂), lithium difluorooxalatoborate (LiBF₂(C₂O₄)), lithium difluorodi (oxalato)borate (LiPF₂(C₂O₄)₂), lithium tetrafluorooxalatophosphate (LiPF₄(C₂O₄)), lithium monofluorophosphate (Li₂PFO₃), and lithium difluorophosphate (LiPF₂O₂).

The content of the electrolyte salt is not particularly limited, and is specifically 0.3 mol/kg to 3.0 mol/kg with respect to the solvent. This is because high ion conductivity can be obtained.

The electrolytic solution may further include any one kind or two or more kinds of additives. This is because a coating film derived from the additive is formed on the surface of each of the positive electrode 21 and the negative electrode 22, so that a decomposition reaction of the electrolytic solution is suppressed. The content of the additive in the electrolytic solution is not particularly limited, and can be arbitrarily set.

The type of the additive is not particularly limited, and specific examples thereof include an unsaturated cyclic carbonic acid ester, a fluorinated cyclic carbonic acid ester, a sulfonic acid ester, a phosphoric acid ester, a dicarboxylic anhydride, a disulfonic anhydride, a sulfonic acid carboxylic acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate.

Specific examples of the dicarboxylic anhydride include succinic anhydride, glutaric anhydride, and maleic anhydride. Specific examples of the disulfonic anhydride include anhydrous ethanedisulfonic acid and anhydrous propanedisulfonic acid. Specific examples of the sulfonic acid carboxylic acid anhydride include 2-sulfobenzoic acid anhydride and 2,2-dioxoxathiolane-5-one. Specific examples of the nitrile compound include octanenitrile, benzonitrile, phthalonitrile, succinonitrile, glutaronitrile, adiponitrile, and cebaconitrile. Specific examples of the isocyanate compound include hexamethylene diisocyanate.

The electrolytic solution is produced according to an exemplary procedure described below. Specifically, an electrolyte salt is added to a solvent, and then a phenyl isothiocyanate compound is added to the solvent. In this case, a benzothiazole compound may be added to the solvent together with the phenyl isothiocyanate compound. As a result, the electrolyte salt or the like is dissolved or dispersed in the solvent, thereby preparing an electrolytic solution.

According to the electrolytic solution, the electrolytic solution contains a phenyl isothiocyanate compound.

As a result, as described above, during charging and discharging of the secondary battery using the electrolytic solution, a favorable coating film derived from the phenyl isothiocyanate compound is formed on the surface of the negative electrode, so that the electrode reactant is less likely to precipitate in the negative electrode. Therefore, when charging and discharging are repeated, the charging and discharging reaction tends to proceed stably and continuously, so that excellent battery characteristics can be obtained.

In particular, when the content of the phenyl isothiocyanate compound in the electrolytic solution is 0.001 wt % to 10 wt %, a favorable coating film derived from the phenyl isothiocyanate compound is easily formed on the surface of the negative electrode, so that a higher effect can be obtained.

When the electrolytic solution further contains the benzothiazole compound, the electrical resistance of the positive electrode is reduced, so that a higher effect can be obtained.

In this case, when the content of the benzothiazole compound in the electrolytic solution is 0.1 wt % to 10 wt %, the electrical resistance of the positive electrode is further reduced, so that a higher effect can be obtained.

When the sum of the content of the phenyl isothiocyanate compound in the electrolytic solution and the content of the benzothiazole compound in the electrolytic solution is 10 wt % or less, the electrical resistance of the positive electrode is sufficiently reduced and the electrode reactant is less likely to sufficiently precipitate in the negative electrode, so that a higher effect can be obtained.

Subsequently, the above-described secondary battery in which the electrolytic solution is used will be described.

The secondary battery described herein is a secondary battery that can obtain a battery capacity by utilizing occlusion and release of an electrode reactant and includes a positive electrode, a negative electrode, and an electrolytic solution.

A charge capacity of the negative electrode is preferably larger than a discharge capacity of the positive electrode. That is, an electrochemical capacity per unit area of the negative electrode is preferably larger than an electrochemical capacity per unit area of the positive electrode. This is to suppress the electrode reactant from precipitating on the surface of the negative electrode during charging.

The type of the electrode reactant is not particularly limited, but is specifically a light metal such as an alkali metal or an alkaline earth metal. Examples of the alkali metal include lithium, sodium, and potassium, and examples of the alkaline earth metal include beryllium, magnesium, and calcium.

In the following, a description is given of an example case where the electrode reactant is lithium. A secondary battery in which the battery capacity is attained by utilizing occlusion and release of lithium is a so-called lithium ion secondary battery. In the lithium ion secondary battery, lithium is occluded and released in an ionic state.

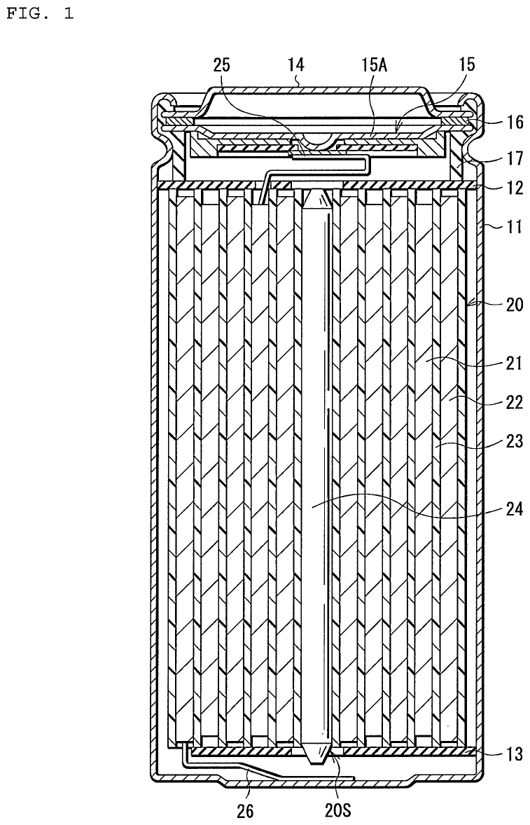

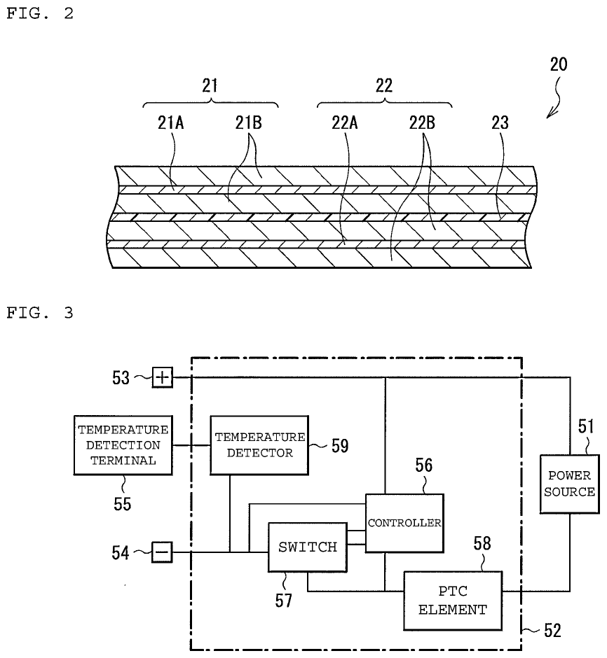

FIG. 1 illustrates a sectional configuration of a secondary battery, and FIG. 2 illustrates a sectional configuration of a battery element 20 illustrated in FIG. 1.

As illustrated in FIGS. 1 and 2, the secondary battery includes a battery can 11, a pair of insulating plates 12 and 13, the battery element 20, a positive electrode lead 25, and a negative electrode lead 26. The secondary battery described herein is a so-called cylindrical secondary battery in which the battery element 20 is housed inside the battery can 11 having a cylindrical shape.

As illustrated in FIG. 1, the battery can 11 is a hollow housing member that houses the battery element 20 and the like. The battery can 11 has an open end at one end and a closed end at the other end. The battery can 11 contains any one kind or two or more kinds of conductive materials such as metal materials, and specific examples of the conductive materials include iron, aluminum, an iron alloy, and an aluminum alloy. A metal material such as nickel may be plated on the surface of the battery can 11.

A battery cover 14, a safety valve mechanism 15, and a heat sensitive resistance element (PTC element) 16 are crimped to the open end portion of the battery can 11 with a gasket 17 interposed therebetween. As a result, the open end of the battery can 11 is sealed by the battery cover 14. Here, the battery cover 14 contains the same material as the material for forming the battery can 11. Each of the safety valve mechanism 15 and the PTC element 16 is provided inside the battery cover 14, and the safety valve mechanism 15 is electrically connected to the battery cover 14 with the PTC element 16 interposed therebetween. The gasket 17 contains an insulating material, and asphalt or the like may be applied to the surface of the gasket 17.

In the safety valve mechanism 15, when the internal pressure of the battery can 11 reaches a certain level or more due to an internal short circuit, external heating, and the like, a disk plate 15A is reversed, and thus the electrical connection between the battery cover 14 and the battery element 20 is disconnected. In order to prevent abnormal heat generation due to a large current, the electrical resistance of the PTC element 16 rises as the temperature rises.

As illustrated in FIG. 1, the insulating plates 12 and 13 are arranged in such a manner of facing each other with the battery element 20 interposed therebetween. Thus, the battery element 20 is sandwiched between the insulating plates 12 and 13.

As illustrated in FIGS. 1 and 2, the battery element 20 is a power generating element including a positive electrode 21, a negative electrode 22, a separator 23, and an electrolytic solution (not illustrated).

The battery element 20 is a so-called wound electrode body. That is, the positive electrode 21 and the negative electrode 22 are laminated on each other with the separator 23 interposed therebetween, and are wound while facing each other with the separator 23 interposed therebetween. A center pin 24 is inserted into a space 20S provided at the winding center of the battery element 20. However, the center pin 24 may be omitted.

As illustrated in FIG. 2, the positive electrode 21 includes a positive electrode current collector 21A and a positive electrode active material layer 21B.

The positive electrode current collector 21A has a pair of surfaces on which the positive electrode active material layer 21B is provided. The positive electrode current collector 21A contains a conductive material such as a metal material, and specific examples of the conductive material include aluminum.

The positive electrode active material layer 21B contains any one kind or two or more kinds of positive electrode active materials capable of occluding and releasing lithium. However, the positive electrode active material layer 21B may further contain any one kind or two or more kinds of other materials such as a positive electrode binder and a positive electrode conductive agent. A method for forming the positive electrode active material layer 21B is not particularly limited, but is specifically a coating method or the like.

Here, since the positive electrode active material layer 21B is provided on both sides of the positive electrode current collector 21A, the positive electrode 21 includes two positive electrode active material layers 21B. However, however, since the positive electrode active material layer 21B is provided only on one surface of the positive electrode current collector 21A on the side where the positive electrode 21 faces the negative electrode 22, the positive electrode 21 may include only one positive electrode active material layer 21B.

The type of the positive electrode active material is not particularly limited, and is specifically a lithium-containing compound or the like. The lithium-containing compound is a compound containing lithium and one kind or two or more kinds of transition metal elements as constituent elements, and may further contain one kind or two or more kinds of other elements as constituent elements. The type of the other element is not particularly limited as long as it is an element other than lithium and the transition metal element, and is specifically an element belonging to any of Groups 2 to 15 of the long periodic table. The type of the lithium-containing compound is not particularly limited, and specific examples thereof include an oxide, a phosphoric acid compound, a silicic acid compound, and a boric acid compound.

Specific examples of the oxide include LiNiO₂, LiCoO₂, LiCO_{0.98}Al_{0.01}Mg_{0.01}O₂, LiNi_{0.5}CO_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode binder contains any one kind or two or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent contains any one kind or two or more kinds of conductive materials such as carbon materials, and specific examples of the carbon material include graphite, carbon black, acetylene black, and Ketjen black. However, the conductive material may be a metal material, a polymer compound, or the like.

As illustrated in FIG. 2, the negative electrode 22 includes a negative electrode current collector 22A and a negative electrode active material layer 22B.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains any one kind or two or more kinds of negative electrode active materials capable of occluding and releasing lithium. However, the negative electrode active material layer 22B may further contain any one kind or two or more kinds of other materials such as a negative electrode binder and a negative electrode conductive agent. The method for forming the negative electrode active material layer 22B is not particularly limited, but is specifically any one kind or two or more kinds of a coating method, a gas phase method, a liquid phase method, a thermal spraying method, a firing method (sintering method), and the like.

Here, since the negative electrode active material layer 22B is provided on both surfaces of the negative electrode current collector 22A, the negative electrode 22 includes two negative electrode active material layers 22B. However, since the negative electrode active material layer 22B is provided only on one surface of the negative electrode current collector 22A on the side where the negative electrode 22 faces the positive electrode 21, the negative electrode 22 may include only one negative electrode active material layer 22B.

The type of the negative electrode active material is not particularly limited, and specific examples thereof include a carbon material, a metal-based material, and the like. This is because a high energy density can be obtained.

Specific examples of the carbon material include graphitizable carbon, non-graphitizable carbon, and graphite (natural graphite and artificial graphite).

The metal-based material is a material including any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

The details of the negative electrode binder are the same as the details of the positive electrode binder, and the details of the negative electrode conductive agent are the same as the details of the positive electrode conductive agent.

As illustrated in FIG. 2, the separator 23 is an insulating porous film interposed between the positive electrode 21 and the negative electrode 22, and allows lithium ions to pass therethrough while preventing contact (short circuit) between the positive electrode 21 and the negative electrode 22. The separator 23 contains a polymer compound such as polyethylene.

The electrolytic solution is impregnated in each of the positive electrode 21, the negative electrode 22, and the separator 23, and has the above-described configuration. That is, the electrolytic solution contains a phenyl isothiocyanate compound.

As illustrated in FIGS. 1 and 2, the positive electrode lead 25 is connected to the positive electrode current collector 21A of the positive electrode 21 and contains a conductive material such as aluminum. The positive electrode lead 25 is electrically connected to the battery cover 14 with the safety valve mechanism 15 interposed therebetween.

As illustrated in FIGS. 1 and 2, the negative electrode lead 26 is connected to the negative electrode current collector 22A of the negative electrode 22 and contains a conductive material such as nickel. The negative electrode lead 26 is electrically connected to the battery can 11.

The secondary battery operates as follows.

During charging, in the battery element 20, lithium is released from the positive electrode 21, and the lithium is occluded in the negative electrode 22 with the electrolytic solution interposed therebetween. On the other hand, during discharging, in the battery element 20, lithium is released from the negative electrode 22, and the lithium is occluded in the positive electrode 21 with the electrolytic solution interposed therebetween. At the time of charge and the time of discharge, lithium is occluded and released in an ionic state.

In the case of manufacturing a secondary battery, after the positive electrode 21 and the negative electrode 22 are produced according to an exemplary procedure described below and an electrolytic solution is prepared, a secondary battery is assembled using the positive electrode 21, the negative electrode 22, and the electrolytic solution, and the stabilization treatment of the assembled secondary battery is performed. The procedure for preparing the electrolytic solution is as described above.

First, a positive electrode active material, a positive electrode binder, and a positive electrode conductive agent are mixed together to obtain a positive electrode mixture. Subsequently, the positive electrode mixture is charged into a solvent to prepare a paste-like positive electrode mixture slurry. The solvent may be an aqueous solvent or an organic solvent. Finally, the positive electrode mixture slurry is applied on both sides of the positive electrode current collector 21A to form the positive electrode active material layer 21B. Thereafter, the positive electrode active material layer 21B may be compression-molded using a roll press machine or the like. In this case, the positive electrode active material layer 21B may be heated or compression molding may be repeated a plurality of times. As a result, since the positive electrode active material layer 21B is formed on both sides of the positive electrode current collector 21A, the positive electrode 21 is produced.

The negative electrode 22 is formed by the same procedure as the production procedure of the positive electrode 21 described above. Specifically, first, a mixture (negative electrode mixture) in which a negative electrode active material, a negative electrode binder, and a negative electrode conductive agent are mixed together is charged into a solvent to prepare a paste-like negative electrode mixture slurry. Subsequently, the negative electrode mixture slurry is applied to both sides of the negative electrode current collector 22A to form the negative electrode active material layer 22B. Thereafter, the negative electrode active material layer 22B may be compression-molded. As a result, since the negative electrode active material layer 22B is formed on both sides of the negative electrode current collector 22A, the negative electrode 22 is produced.

First, the positive electrode lead 25 is connected to the positive electrode current collector 21A of the positive electrode 21 by a joining method such as a welding method, and the negative electrode lead 26 is connected to the negative electrode current collector 22A of the negative electrode 22 by a joining method such as a welding method. Subsequently, the positive electrode 21 and the negative electrode 22 are laminated on each other with the separator 23 interposed therebetween, and then the positive electrode 21, the negative electrode 22, and the separator 23 are wound to prepare a wound body (not illustrated) having the space 20S. This wound body has the same configuration as the configuration of the battery element 20 except that each of the positive electrode 21, the negative electrode 22, and the separator 23 is not impregnated with the electrolytic solution. Subsequently, the center pin 24 is inserted into the space 20S of the wound body.

Subsequently, the wound body and the insulating plates 12 and 13 are housed inside the battery can 11 in a state where the wound body is sandwiched between the insulating plates 12 and 13. In this case, the positive electrode lead 25 is connected to the safety valve mechanism 15 by a joining method such as a welding method, and the negative electrode lead 26 is connected to the battery can 11 by a joining method such as a welding method. Subsequently, the wound body is impregnated with the electrolytic solution by injecting the electrolytic solution into the battery can 11. As a result, each of the positive electrode 21, the negative electrode 22, and the separator 23 is impregnated with the electrolytic solution, and thus the battery element 20 is prepared.

Finally, the battery cover 14, the safety valve mechanism 15, and the PTC element 16 are housed inside the battery can 11, and then the battery can 11 is crimped with the gasket 17 interposed therebetween. As a result, the battery cover 14, the safety valve mechanism 15, and the PTC element 16 are fixed to the battery can 11, and the battery element 20 is enclosed inside the battery can 11, so that the secondary battery is assembled.

The assembled secondary battery is charged and discharged. Various conditions such as an environmental temperature, the number of times of charge and discharge (the number of cycles), and charge and discharge conditions can be arbitrarily set. As a result, since a coating film is formed on the surface of each of the positive electrode 21 and the negative electrode 22, the state of the secondary battery is electrochemically stabilized. Thus, the secondary battery is completed.

According to the secondary battery, the secondary battery includes an electrolytic solution, and the electrolytic solution has the above-described configuration. In this case, for the reasons described above, when charging and discharging are repeated, the charging and discharging reaction tends to proceed stably and continuously, so that the discharge capacity is less likely to decrease. Accordingly, excellent battery characteristics can be obtained.

In particular, when the secondary battery is a lithium ion secondary battery, a sufficient battery capacity can be stably obtained using occlusion and release of lithium, so that a higher effect can be obtained.

Other actions and effects relating to the secondary battery are similar to the other actions and the effects relating to the electrolytic solution.

The configuration of the above-described secondary battery can be appropriately changed as described below according to an embodiment. However, any two or more of a series of modification examples described below may be combined with each other.

A case where the battery structure of the secondary battery is cylindrical has been described. However, although not specifically illustrated here, the type of the battery structure is not particularly limited, and thus may be a laminate film type, a square type, a coin type, a button type, and the like. In this case as well, a similar effect can be attained.

The separator 23 which is a porous film was used. However, although not specifically illustrated in the drawings, a laminated type separator including a polymer compound layer may be used.

Specifically, the laminated type separator includes a porous film having a pair of surfaces and a polymer compound layer provided on one surface or both surfaces of the porous film. This is because the adhesive property of the separator to each of the positive electrode 21 and the negative electrode 22 is improved, so that positional displacement (winding deviation) of the battery element 20 is suppressed. Accordingly, when a decomposition reaction or the like of the electrolytic solution occurs, the swelling of the secondary battery is suppressed. The polymer compound layer contains a polymer compound such as a polyvinylidene fluoride. This is because polyvinylidene fluoride or the like is excellent in physical strength, and electrochemically stable.

One or both of the porous film and the polymer compound layer may contain any one kind or two or more kinds of a plurality of insulating particles. This is because the plurality of insulating particles promote heat dissipation at the time of heat generation of the secondary battery, thereby improving the safety (heat resistance) of the secondary battery. The insulating particles contain one or both of an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In the case of producing a laminated type separator, a precursor solution containing a polymer compound, a solvent, and the like is prepared, and then the precursor solution is applied to one surface or both surfaces of the porous film. In this case, a plurality of insulating particles may be added to the precursor solution as necessary.

Also in the case of using the laminated type separator, lithium ions can move between the positive electrode 21 and the negative electrode 22, so that the same effect can be obtained. In this case, in particular, as described above, the safety of the secondary battery is suppressed, so that a higher effect can be obtained.

An electrolytic solution which was a liquid electrolyte was used. However, although not specifically illustrated in the drawing, an electrolyte layer that is a gel-like electrolyte may be used.

In the battery element 20 using an electrolyte layer, the positive electrode 21 and the negative electrode 22 are laminated on each other with the separator 23 and the electrolyte layer interposed therebetween, and the positive electrode 21, the negative electrode 22, the separator 23, and the electrolyte layer are wound. The electrolyte layer is interposed between the positive electrode 21 and the separator 23, and is interposed between the negative electrode 22 and the separator 23, and thus the battery element 20 includes two electrolyte layers. However, the battery element 20 may include only one electrolyte layer.

Specifically, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. In the case of forming an electrolyte layer, a precursor solution containing an electrolytic solution, a polymer compound, a solvent, and the like is prepared, and then the precursor solution is applied to one surface or both surfaces of each of the positive electrode 21 and the negative electrode 22.

Also in the case of using the electrolyte layer, lithium ions can move between the positive electrode 21 and the negative electrode 22 with the electrolyte layer interposed therebetween, so that the same effect can be obtained. In this case, in particular, as described above, leakage of the electrolytic solution is prevented, so that a higher effect can be obtained.

The application (application example) of the secondary battery is not particularly limited. The secondary battery to be used as a power source may be a main power source or an auxiliary power source in electronic devices, electric vehicles, and the like. The main power source is a power supply that is preferentially used regardless of the presence or absence of another power source. The auxiliary power source may be a power source which is used instead of the main power supply, or is a power source which is switched from the main power source.

Specific examples of the application of the secondary battery are as described below. The secondary battery can be applied to electronic devices such as a video camcorder, a digital still camera, a mobile phone, a notebook personal computer, a headphone stereo, a portable radio, and a portable information terminal. The secondary battery can be applied to storage devices such as backup power sources and memory cards. The secondary battery can be applied to power tools such as electric drills and electric saws. The secondary battery can be applied to a battery pack mounted on an electronic device or the like. The secondary battery can be applied to medical electronic devices such as pacemakers and hearing aids. The secondary battery can be applied to electric vehicles such as electric cars (including hybrid cars). The secondary battery can be applied to power storage systems such as domestic or industrial battery systems that store electric power in preparation for emergency or the like. In these applications, one secondary battery may be used, or a plurality of secondary batteries may be used.

A single battery or an assembled battery may be used in the battery pack. The electric vehicle is a vehicle which operates (travels) using the secondary battery as a power source for driving, and may be a hybrid automobile including other driving source in addition to the secondary battery. In a home electric power storage system, home electric products and the like can be used using electric power accumulated in the secondary battery as an electric power storage source.

Here, an example of application examples of the secondary batteries will be specifically described. The configurations of the application examples explained below are merely examples, and may be changed as appropriate.

FIG. 3 illustrates a block configuration of the battery pack. The battery pack to be described herein is a battery pack (so-called soft pack) including one secondary battery and is mounted on an electronic device typified by a smartphone.

The battery pack includes a power source 51 and a circuit board 52, as illustrated in FIG. 3. The circuit board 52 is connected to the power source 51, and includes a positive electrode terminal 53, a negative electrode terminal 54, and a temperature detection terminal 55.

The power source 51 includes one secondary battery. In the secondary battery, the positive electrode lead is connected to the positive electrode terminal 53, and the negative electrode lead is connected to the negative electrode terminal 54. The power source 51 can be connected to the outside via the positive electrode terminal 53 and the negative electrode terminal 54, and thus can be charged and discharged. The circuit board 52 includes a controller 56, a switch 57, a PTC element 58, and a temperature detector 59. However, the PTC element 58 may be omitted.

The controller 56 includes a central processing unit (CPU), a memory, and the like, and controls the operation of the entire battery pack. The controller 56 performs detection and control of the use state of the power source 51 as necessary.

When a voltage of the power source 51 (secondary battery) reaches an overcharge detection voltage or an overdischarge detection voltage, the controller 56 causes the switch 57 to be disconnected so that a charge current does not flow into a current path of the power source 51. The overcharge detection voltage is not particularly limited and is specifically 4.20 V±0.05 V and the overdischarge detection voltage is not particularly limited and is specifically 2.40 V±0.1 V.

The switch 57 includes a charge control switch, a discharge control switch, a charge diode, a discharge diode, and the like, and switches connection or disconnection between the power source 51 and an external device according to an instruction of the controller 56. The switch 57 includes a field effect transistor (MOSFET) using a metal oxide semiconductor, and the like, and the charge and discharge currents are detected based on a turn-on resistance of the switch 57.

This temperature detector 59 includes a temperature detecting element such as a thermistor. The temperature detector 59 measures the temperature of the power source 51 using the temperature detection terminal 55 and outputs the measurement result of temperature to the controller 56. The measurement result of the temperature measured by the temperature detector 59 is used, for example, in a case where the controller 56 performs charge and discharge control at the time of abnormal heat generation and in a case where the controller 56 performs a correction process at the time of calculating remaining capacity.

### EXAMPLES

Description is given on examples of the present technology according to an embodiment.

### Examples 1 to 26 and Comparative Examples 1 and 2

As described below, after a secondary battery was manufactured, battery characteristics of the secondary battery were evaluated.

### [Manufacture of Secondary Battery]

A cylindrical lithium ion secondary battery illustrated in FIGS. 1 and 2 was manufactured according to the procedure described below.

### (Production of Positive Electrode)

First, 91 parts by mass of a positive electrode active material (lithium cobalt oxide (LiCoO₂) as a lithium-containing compound (oxide)), 3 parts by mass of a positive electrode binder (polyvinylidene fluoride), and 6 parts by mass of a positive electrode conductive agent (graphite) were mixed together to obtain a positive electrode mixture. Subsequently, the positive electrode mixture was charged into a solvent (N-methyl-2-pyrrolidone as an organic solvent), and then the solvent was stirred to prepare a paste-like positive electrode mixture slurry. Subsequently, the positive electrode mixture slurry was applied to both sides of the positive electrode current collector 21A (strip-shaped aluminum foil having a thickness of 12 μm) using a coating apparatus, and then the positive electrode mixture slurry was dried to form the positive electrode active material layer 21B. Finally, the positive electrode active material layer 21B was compression-molded using a roll press machine. Thereby, the positive electrode 21 was produced.

### (Production of Negative Electrode)

First, 93 parts by mass of a negative electrode active material and 7 parts by mass of a negative electrode binder (polyvinylidene fluoride) were mixed together to obtain a negative electrode mixture. As the negative electrode active material, a mixture of 63 parts by mass of a carbon material (artificial graphite) and 30 parts by mass of a metal-based material (silicon oxide (SiO)) was used. Subsequently, the negative electrode mixture was charged into a solvent (N-methyl-2-pyrrolidone as an organic solvent), and then the solvent was stirred to prepare a paste-like negative electrode mixture slurry. Subsequently, the negative electrode mixture slurry was applied to both sides of the negative electrode current collector 22A (strip-shaped copper foil having a thickness of 15 μm) using a coating apparatus and then dried to form the negative electrode active material layer 22B. Finally, the negative electrode active material layer 22B was compression-molded using a roll press machine. Thereby, the negative electrode 22 was produced.

### (Preparation of Electrolytic Solution)

First, a solvent (ethylene carbonate as a cyclic carbonic acid ester and dimethyl carbonate as a chain carbonic acid ester) was prepared. The mixing ratio (weight ratio) of solvent was set to ethylene carbonate: dimethyl carbonate=30:70. Subsequently, an electrolyte salt (lithium hexafluorophosphate (LiPF₆) as a lithium salt) was added to the solvent and then the solvent was stirred. The content of electrolyte salt was set to 1.2 mol/kg with respect to the solvent. Finally, a phenyl isothiocyanate compound was added to the solvent added with the electrolyte salt, and then the solvent was stirred. The types of the phenyl isothiocyanate compound are as shown in Tables 1 and 2. Thereby, the electrolytic solution was prepared.

Incidentally, for comparison, an electrolytic solution was prepared by the same procedure except that a phenyl isothiocyanate compound was not used.

In addition, an electrolytic solution was prepared by the same procedure except that a benzothiazole compound was used instead of the phenyl isothiocyanate compound. The types of the benzothiazole compound are as shown in Table 2.

### (Assembly of Secondary Battery)

First, the positive electrode lead 25 (aluminum foil) was welded to the positive electrode current collector 21A of the positive electrode 21, and the negative electrode lead 26 (copper foil) was welded to the negative electrode current collector 22A of the negative electrode 22.

Subsequently, the positive electrode 21 and the negative electrode 22 were laminated on each other with the separator 23 (microporous polyethylene film having a thickness of 15 μm) interposed therebetween and then the positive electrode 21, the negative electrode 22, and the separator 23 were wound to form a wound body having the space 20S. Subsequently, the center pin 24 was inserted into the space 20S of the wound body.

Subsequently, the insulating plates 12 and 13 were housed inside the battery can 11 together with the wound body. In this case, the positive electrode lead 25 was welded to the safety valve mechanism 15, and the negative electrode lead 26 was welded to the battery can 11. Subsequently, the electrolytic solution was injected into the battery can 11. By this, the wound body was impregnated with the electrolytic solution, and the battery element 20 was thus produced.

Finally, the battery cover 14, the safety valve mechanism 15, and the PTC element 16 were housed inside the battery can 11, and then the battery can 11 was crimped with the gasket 17 interposed therebetween. As a result, the battery can 11 was enclosed, so that the secondary battery was assembled.

### (Stabilization of Secondary Battery)

The secondary battery was charged and discharged for one cycle in an ambient temperature environment (temperature=23° C.). During charging, constant current charging was performed at a current of 0.1 C until the voltage reached 4.2 V, and then constant voltage charging was performed at a voltage of 4.2 V until the current reached 0.05 C. During discharging, constant current discharge was performed at a current of 0.1 C until the voltage reached 3.0 V. 0.1 C refers to a current value at which the battery capacity (theoretical capacity) can be discharged in 10 hours, and 0.05 C refers to a current value at which the battery capacity can be discharged in 20 hours. Thus, the secondary battery was completed.

After completion of the secondary battery, the electrolytic solution was recovered from the secondary battery, and then the electrolytic solution was analyzed using ICP emission spectrometry. As a result, the content (wt %) of the phenyl isothiocyanate compound in the electrolytic solution and the content (wt %) of the benzothiazole compound in the electrolytic solution were measured, and the results thereof are as shown in Tables 1 and 2.

### [Evaluation on Battery Characteristics]

The normal temperature cycle characteristics and the low temperature cycle characteristics as battery characteristics were evaluated by the procedure described below, and the results shown in Tables 1 and 2 were obtained.

### (Normal Temperature Cycle Characteristics)

First, the secondary battery was charged and discharged in an ambient temperature environment (temperature=23° C.), thereby measuring the discharge capacity (discharge capacity at the first cycle). Subsequently, the secondary battery was repeatedly charged and discharged in the same environment until the number of cycles reached 100 cycles to measure the discharge capacity (discharge capacity at the 100th cycle). Finally, the normal temperature retention rate, which is an index for evaluating normal temperature cycle characteristics, was calculated based on a calculation formula of normal temperature retention rate (%)=(discharge capacity at the 100th cycle/discharge capacity at the first cycle)×100. The charge and discharge conditions were the same as those at the time of stabilization of the secondary battery.

### (Low Temperature Cycle Characteristics)

First, the secondary battery was stored in a high-temperature environment (temperature=60° C.) (storage time=30 days). Subsequently, after the secondary battery was allowed to stand still (standing time=3 hours) in a low-temperature environment (temperature=0° C.), the secondary battery was charged and discharged, thereby measuring the secondary battery (discharge capacity at the first cycle). Subsequently, the secondary battery was repeatedly charged and discharged in the same environment until the number of cycles reached 100 cycles to measure the discharge capacity (discharge capacity at the 100th cycle). Finally, the low temperature retention rate, which is an index for evaluating low temperature cycle characteristics, was calculated based on a calculation formula of low temperature retention rate (%)=(discharge capacity at the 100th cycle/discharge capacity at the first cycle)×100. The charge and discharge conditions were the same as those at the time of stabilization of the secondary battery.

TABLE 1

| | Phenyl | | | | Normal | Low |
|---|---|---|---|---|---|---|
| | isothiocyanate | | Benzothiazole | | temper- | temper- |
| | compound | | compound | | ature | ature |
| | | Content | | Content | retention | retention |
| | Type | (wt %) | Type | (wt %) | rate (%) | rate (%) |
| Example 1 | Formula | 0.001 | — | — | 71 | 61 |
| Example 2 | (1-1) | 0.01 | — | — | 73 | 63 |
| Example 3 | | 0.1 | — | — | 75 | 65 |
| Example 4 | | 0.5 | — | — | 77 | 69 |
| Example 5 | | 1 | — | — | 77 | 65 |
| Example 6 | | 5 | — | — | 75 | 62 |
| Example 7 | | 10 | — | — | 72 | 61 |
| Example 8 | | 11 | — | — | 69 | 59 |
| Example 9 | Formula | 0.5 | — | — | 75 | 64 |
| | (1-2) | | | | | |
| Example 10 | Formula | 0.5 | — | — | 74 | 62 |
| | (1-3) | | | | | |
| Example 11 | Formula | 0.5 | — | — | 74 | 63 |
| | (1-4) | | | | | |
| Example 12 | Formula | 0.5 | — | — | 76 | 65 |
| | (1-5) | | | | | |
| Example 13 | Formula | 0.5 | — | — | 74 | 65 |
| | (1-6) | | | | | |
| Example 14 | Formula | 0.5 | — | — | 75 | 66 |
| | (1-7) | | | | | |
| Example 15 | Formula | 0.5 | — | — | 74 | 68 |
| | (1-8) | | | | | |
| Example 16 | Formula | 0.5 | — | — | 73 | 64 |
| | (1-9) | | | | | |
| Example 17 | Formula | 0.5 | — | — | 72 | 66 |
| | (1-10) | | | | | |
| Example 18 | Formula | 0.5 | — | — | 73 | 66 |
| | (1-11) | | | | | |
| Example 19 | Formula | 0.5 | — | — | 74 | 64 |
| | (1-12) | | | | | |
| Example 20 | Formula | 0.5 | — | — | 75 | 63 |
| | (1-13) | | | | | |

TABLE 2

| | | | | | Normal | Low |
|---|---|---|---|---|---|---|
| | Phenyl | | | | temper- | temper- |
| | isothiocyanate | | Benzothiazole | | ature | ature |
| | compound | | compound | | reten- | reten- |
| | | Content | | Content | tion | tion |
| | Type | (wt %) | Type | (wt %) | rate (%) | rate (%) |
| Example 21 | Formula | 0.5 | — | — | 74 | 63 |
| | (1-14) | | | | | |
| Example 22 | Formula | 0.5 | — | — | 74 | 64 |
| | (1-15) | | | | | |
| Example 23 | Formula | 0.5 | — | — | 73 | 65 |
| | (1-16) | | | | | |
| Example 24 | Formula | 0.5 | | | 75 | 62 |
| | (1-17) | | | | | |
| Example 25 | Formula | 0.5 | | | 76 | 64 |
| | (1-18) | | | | | |
| Example 26 | Formula | 0.5 | | | 75 | 64 |
| | (1-19) | | | | | |
| Comparative | — | — | — | — | 68 | 55 |
| Example 1 | | | | | | |
| Comparative | — | — | Formula | 1 | 74 | 56 |
| Example 2 | | | (2-1) | | | |

As shown in Tables 1 and 2, each of the normal temperature retention rate and the low temperature retention rate varied depending on the configuration of the electrolytic solution.

Hereinafter, each of the normal temperature retention rate and the low temperature retention rate when the electrolytic solution does not contain phenyl isothiocyanate or a benzothiazole compound (Comparative Example 1) is used as a comparison reference.

When the electrolytic solution contained a benzothiazole compound instead of the phenyl isothiocyanate compound (Comparative Example 2), the normal temperature retention rate increased, but the low temperature retention rate hardly increased.

On the other hand, when the electrolytic solution contained a phenyl isothiocyanate compound (Examples 1 to 26), the normal temperature retention rate increased, and the low temperature retention rate also increased. In this case, particularly, the low temperature retention rate significantly increased.

In particular, when the electrolytic solution contained a phenyl isothiocyanate compound (Examples 1 to 26), the tendencies described below were obtained. First, when the type of the phenyl isothiocyanate compound was changed, each of the normal temperature retention rate and the low temperature retention rate increased. Secondly, when the content of the phenyl isothiocyanate compound in the electrolytic solution was 0.001 wt % to 10 wt %, each of the normal temperature retention rate and the low temperature retention rate further increased.

### Examples 27 to 49

As shown in Table 3, a secondary battery was produced by the same procedure as in Example 4, except that a benzothiazole compound was contained in the electrolytic solution, and then the battery characteristics were evaluated. The types of the benzothiazole are as shown in Table 3.

In the case of preparing the electrolytic solution, a benzothiazole compound was added to the solvent added with the electrolyte salt together with the phenyl isothiocyanate compound. After completion of the secondary battery, the electrolytic solution was analyzed using ICP emission spectrometry to measure the content (wt %) of the benzothiazole compound in the electrolytic solution, and the results thereof were as shown in Table 3.

TABLE 3

| | | | | | Normal | Low |
|---|---|---|---|---|---|---|
| | Phenyl | | | | temper- | temper- |
| | isothiocyanate | | Benzothiazole | | ature | ature |
| | compound | | compound | | reten- | reten- |
| | | Content | | Content | tion | tion |
| | Type | (wt %) | Type | (wt %) | rate (%) | rate (%) |
| Example 4 | Formula | 0.5 | — | — | 77 | 69 |
| Example 27 | (1-1) | | Formula | 0.1 | 79 | 73 |
| Example 28 | | | (2-1) | 0.5 | 82 | 74 |
| Example 29 | | | | 1 | 88 | 77 |
| Example 30 | | | | 5 | 87 | 75 |
| Example 31 | | | | 9 | 80 | 72 |
| Example 32 | | | | 10 | 79 | 72 |
| Example 33 | | | | 11 | 77 | 71 |
| Example 34 | | | Formula | 1 | 88 | 74 |
| | | | (2-2) | | | |
| Example 35 | | | Formula | 1 | 87 | 75 |
| | | | (2-3) | | | |
| Example 36 | | | Formula | 1 | 87 | 74 |
| | | | (2-4) | | | |
| Example 37 | | | Formula | 1 | 86 | 74 |
| | | | (2-5) | | | |
| Example 38 | | | Formula | 1 | 87 | 73 |
| | | | (2-6) | | | |
| Example 39 | | | Formula | 1 | 86 | 72 |
| | | | (2-7) | | | |
| Example 40 | | | Formula | 1 | 87 | 74 |
| | | | (2-8) | | | |
| Example 41 | | | Formula | 1 | 88 | 73 |
| | | | (2-9) | | | |
| Example 42 | | | Formula | 1 | 85 | 75 |
| | | | (2-10) | | | |
| Example 43 | | | Formula | 1 | 82 | 72 |
| | | | (2-11) | | | |
| Example 44 | | | Formula | 1 | 83 | 75 |
| | | | (2-12) | | | |
| Example 45 | | | Formula | 1 | 85 | 74 |
| | | | (2-13) | | | |
| Example 46 | | | Formula | 1 | 82 | 76 |
| | | | (2-14) | | | |
| Example 47 | | | Formula | 1 | 83 | 73 |
| | | | (2-15) | | | |
| Example 48 | | | Formula | 1 | 81 | 75 |
| | | | (2-16) | | | |
| Example 49 | | | Formula | 1 | 80 | 74 |
| | | | (2-17) | | | |

As shown in Table 3, when the electrolytic solution contained a benzothiazole compound (Examples 27 to 49), as compared with a case where the electrolytic solution did not contain a benzothiazole compound (Example 4), a high normal temperature retention rate equal to or higher than that of the comparative case was obtained, and the low temperature retention rate further increased.

In particular, when the electrolytic solution contained a benzothiazole compound (Examples 27 to 49), the tendencies described below were obtained. First, when the type of the benzothiazole compound was changed, a high normal temperature retention rate and a high low temperature retention rate were obtained. Secondly, when the content of the benzothiazole compound in the electrolytic solution was 0.1 wt % to 10 wt %, not only the low temperature retention rate was further increased, but also the normal temperature retention rate was further increased.

### Examples 50 to 54

As shown in Table 4, a secondary battery was produced by the same procedure as in Example 28, except that each of the content of the phenyl isothiocyanate compound in the electrolytic solution and the content of the benzothiazole compound in the electrolytic solution was changed, and then the battery characteristics were evaluated.

After completion of the secondary battery, the electrolytic solution was analyzed using ICP emission spectrometry to measure the sum (wt %) of the content of the phenyl isothiocyanate compound in the electrolytic solution and the content of the benzothiazole compound in the electrolytic solution, and the results thereof were as shown in Table 4.

TABLE 4

| | Phenyl | | | | | | |
|---|---|---|---|---|---|---|---|
| | isothiocyanate | | Benzothiazole | | | Normal | Low |
| | compound | | compound | | | temperature | temperature |
| | | Content | | Content | Sum | retention | retention |
| | Type | (wt %) | Type | (wt %) | (wt %) | rate (%) | rate (%) |
| Example | Formula | 0.1 | Formula | 0.1 | 0.2 | 80 | 74 |
| 50 | (1-1) | | (2-1) | | | | |
| Example | | 0.5 | | 0.5 | 1 | 82 | 74 |
| 28 | | | | | | | |
| Example | | 1 | | 1 | 2 | 86 | 75 |
| 51 | | | | | | | |
| Example | | 2 | | 3 | 5 | 82 | 72 |
| 52 | | | | | | | |
| Example | | 5 | | 5 | 10 | 80 | 71 |
| 53 | | | | | | | |
| Example | | 5 | | 6 | 11 | 79 | 72 |
| 54 | | | | | | | |

As shown in Table 4, when the sum was 10 wt % or less (Examples 28 and 50 to 53), as compared with a case where the sum was larger than 10 wt % (Example 54), the normal temperature retention rate further increased while a high low temperature retention rate was secured.

From the results shown in Tables 1 to 4, when the electrolytic solution contained a phenyl isothiocyanate compound, not only a high normal temperature retention rate but also a high low temperature retention rate was obtained. Therefore, in the secondary battery using the electrolytic solution, both the normal temperature cycle characteristics and the low temperature cycle characteristics were improved, so that excellent battery characteristics could be obtained.

Although the present technology has been described above with reference to the embodiment and the examples, the configurations of the present technology are not limited to the configurations described in the embodiment and the examples, and are therefore modifiable in a variety of ways.

For example, a case where the element structure of the battery element is a winding type has been described. However, the element structure of the battery element is not particularly limited, and may be other element structure such as a laminated type or a zigzag folded type. In the laminated type, the positive electrode and the negative electrode are alternately laminated with the separator interposed therebetween, and in the zigzag folded type, the positive electrode and the negative electrode are folded in a zigzag manner while facing each other with the separator interposed therebetween.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode; a negative electrode; and an electrolytic solution,
wherein the electrolytic solution contains a phenyl isothiocyanate compound represented by Formula (1):

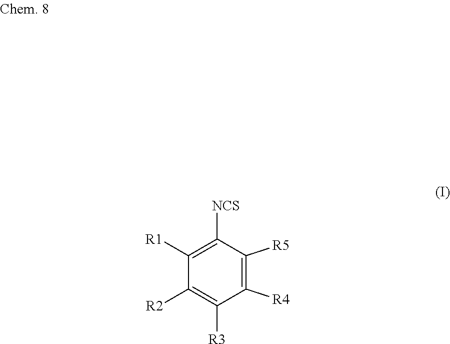

where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.
   <2>

The secondary battery according to <1>, in which a content of the phenyl isothiocyanate compound in the electrolytic solution is 0.001 wt % or more and 10 wt % or less.

<3>

The secondary battery according to <1> or <2>, in which the electrolytic solution further contains a benzothiazole compound represented by Formula (2):

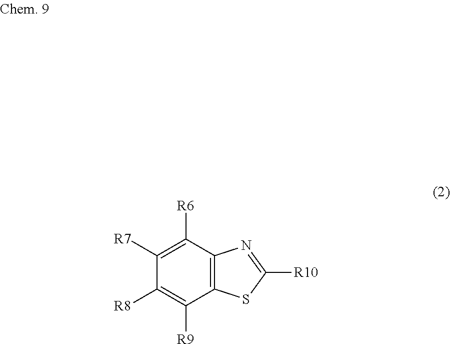

where each of R6, R7, R8, R9, and R10 is any of hydrogen, fluorine, an amino group, an alkyl group, a fluorinated alkyl group, an alkoxy group, a fluorinated alkoxy group, an aryl group, a fluorinated aryl group, a carboxylic acid ester group, and a group in which two or more kinds thereof are bonded to each other.
   <4>

The secondary battery according to <3>, in which a content of the benzothiazole compound in the electrolytic solution is 0.1 wt % or more and 10 wt % or less.

<5>

The secondary battery according to <4>, in which
the content of the phenyl isothiocyanate compound in the electrolytic solution is 0.001 wt % or more and 10 wt % or less, and
a sum of the content of the phenyl isothiocyanate compound in the electrolytic solution and the content of the benzothiazole compound in the electrolytic solution is 10 wt % or less.

<6>

The secondary battery according to any one of <1> to <5>, which is a lithium ion secondary battery.

<7>

A secondary battery-use electrolytic solution containing a phenyl isothiocyanate compound represented by Formula (1):

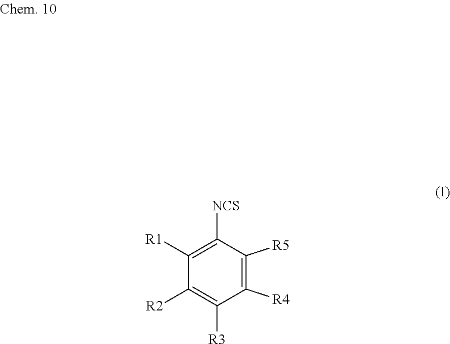

where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention claimed is:

1. A secondary battery comprising:
a positive electrode;
a negative electrode; and
an electrolytic solution,
wherein the electrolytic solution contains a phenyl isothiocyanate compound represented by Formula (1): 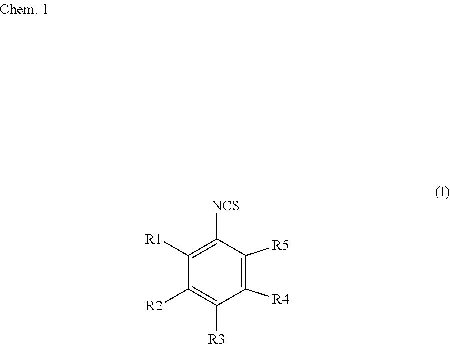
where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.

2. The secondary battery according to claim 1, wherein a content of the phenyl isothiocyanate compound in the electrolytic solution is 0.001 wt % or more and 10 wt % or less.

3. The secondary battery according to claim 1, wherein the electrolytic solution further contains a benzothiazole compound represented by Formula (2): 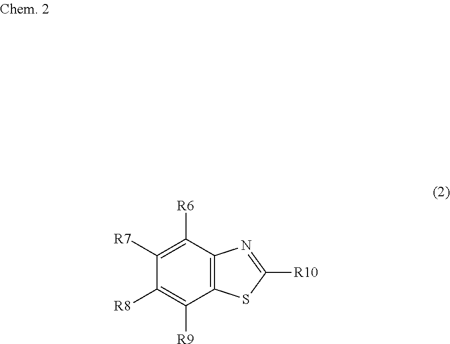
where each of R6, R7, R8, R9, and R10 is any of hydrogen, fluorine, an amino group, an alkyl group, a fluorinated alkyl group, an alkoxy group, a fluorinated alkoxy group, an aryl group, a fluorinated aryl group, a carboxylic acid ester group, and a group in which two or more kinds thereof are bonded to each other.

4. The secondary battery according to claim 3, wherein a content of the benzothiazole compound in the electrolytic solution is 0.1 wt % or more and 10 wt % or less.

5. The secondary battery according to claim 4, wherein
the content of the phenyl isothiocyanate compound in the electrolytic solution is 0.001 wt % or more and 10 wt % or less, and
a sum of the content of the phenyl isothiocyanate compound in the electrolytic solution and the content of the benzothiazole compound in the electrolytic solution is 10 wt % or less.

6. The secondary battery according to claim 1, which is a lithium ion secondary battery.

7. A secondary battery-use electrolytic solution comprising a phenyl isothiocyanate compound represented by Formula (1): 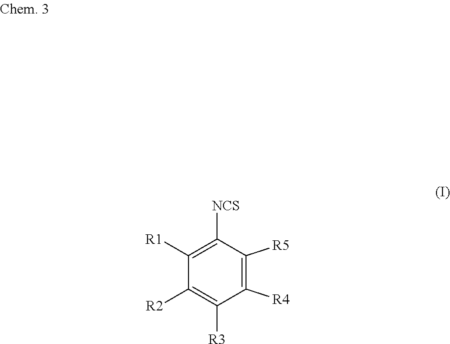
where each of R1, R2, R3, R4, and R5 is any of hydrogen, fluorine, an alkyl group, a fluorinated alkyl group, an alkoxy group, a fluorinated alkoxy group, an aryl group, and a fluorinated aryl group.
